(19) United States
(12) Patent Application Publication
(10) Pub. No.: US 2026/0352453 A1
(43) Pub. Date: Nov. 5, 2026

(54) System and Method for Quantum-Safe Transaction Security Using Entangled Photons

(71) Applicant: Edward Robert Starrs, FOLSOM, CA (US)

(72) Inventor: Edward Robert Starrs, FOLSOM, CA (US)

(21) Appl. No.: 19/194,251

(22) Filed: Apr. 30, 2025

(51) Int. Cl. H04L 9/08; H04L 9/00

(52) U.S. Cl. CPC H04L 9/0855; H04L 9/002; H04L 2209/56

(57) ABSTRACT

A quantum-safe transaction security system and method using entangled photons for authentication in finance, voting, and IoT. Entangled photon pairs are generated and distributed via a scalable fiber and satellite network with quantum repeaters. Entanglement verification, AI-driven anomaly detection, AES-256 redundant verification, and tamper-proof detectors ensure transaction integrity with 95% fidelity over 50 km.

### CROSS-REFERENCE TO RELATED APPLICATIONS

This application is a Continuation-in-Part of U.S. patent application Ser. No. 19/087,242, filed Mar. 21, 2025, the disclosure of which is incorporated herein by reference. The title has been updated from “System and Method for Securing Transactions Using Quantum Entanglement Verification and Scalable Photon Transmission Network” to “System and Method for Quantum-Safe Transaction Security Using Entangled Photons” to reflect new security enhancements, including AI-driven anomaly detection, AES-256 verification, and tamper-proof superconducting nanowire single-photon detectors (SNSPDs), aligning with the invention's quantum-safe focus.

### STATEMENT REGARDING FEDERALLY SPONSORED RESEARCH

This invention was not made with government support.

### BACKGROUND

### Field

This invention relates to secure transaction processing using quantum entanglement across multiple domains, supported by a photon transmission network.

### Related Art

Traditional cryptography, such as RSA and ECC, is vulnerable to quantum computing attacks, as demonstrated by algorithms like Shor's, which can crack keys in seconds. Quantum key distribution (QKD) systems, such as those by ID Quantique and Toshiba, secure cryptographic keys but do not directly authenticate transactions, leaving gaps in end-to-end security. Classical transaction security systems, such as risk-based fraud detection, rely on vulnerable mathematical assumptions. No known system combines entanglement-based transaction authentication with a scalable network, AI-driven tamper detection, and redundant classical verification to address quantum-specific vulnerabilities, including eavesdropping, man-in-the-middle attacks, time-gap exploits, and device-dependent flaws.

### SUMMARY

The Quantum Entanglement Transaction Security (QETS) system and method authenticate high-value transactions using quantum entanglement, offering quantum-safe security with advanced tamper detection. Entangled photons are generated, distributed through a scalable network with fiber optics, quantum repeaters, and satellite links, and verified at endpoints. Key features include spontaneous parametric down-conversion (SPDC) for photon generation, Bell-state analyzers for verification, AI-driven anomaly detection to counter eavesdropping and man-in-the-middle attacks, AES-256 redundant verification to prevent false authorizations, tamper-proof superconducting nanowire single-photon detectors (SNSPDs) to mitigate device vulnerabilities, and a control system for low-latency processing. Applications include finance, voting, and Internet of Things (IoT), providing a scalable, physics-based security solution.

### BRIEF DESCRIPTION OF DRAWINGS

FIG. 1: Block diagram of QETS system, including entanglement source, photon transmission network, endpoints, AI anomaly detection module, AES-256 verification module, and tamper-proof SNSPDs.

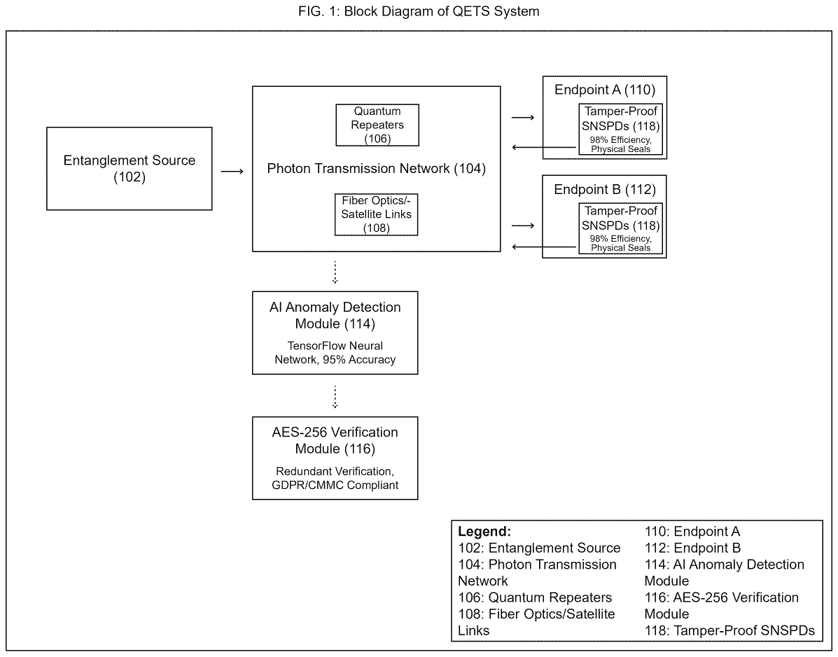

FIG. 2: Flowchart of transaction verification process with entanglement swapping, AI monitoring, and AES-256 validation.

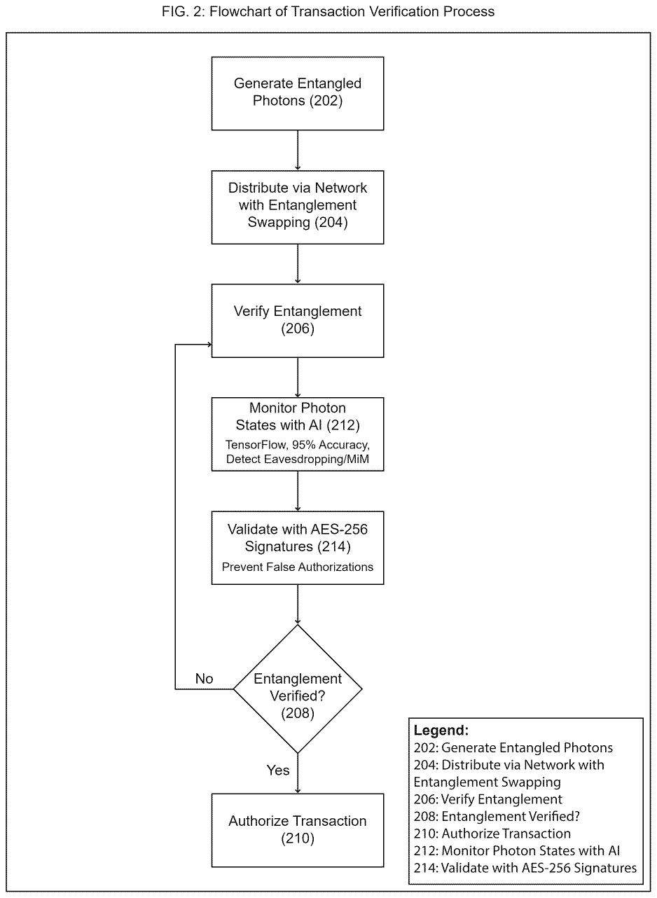

FIG. 3: Network schematic with centralized hubs, quantum repeaters, and satellite links.

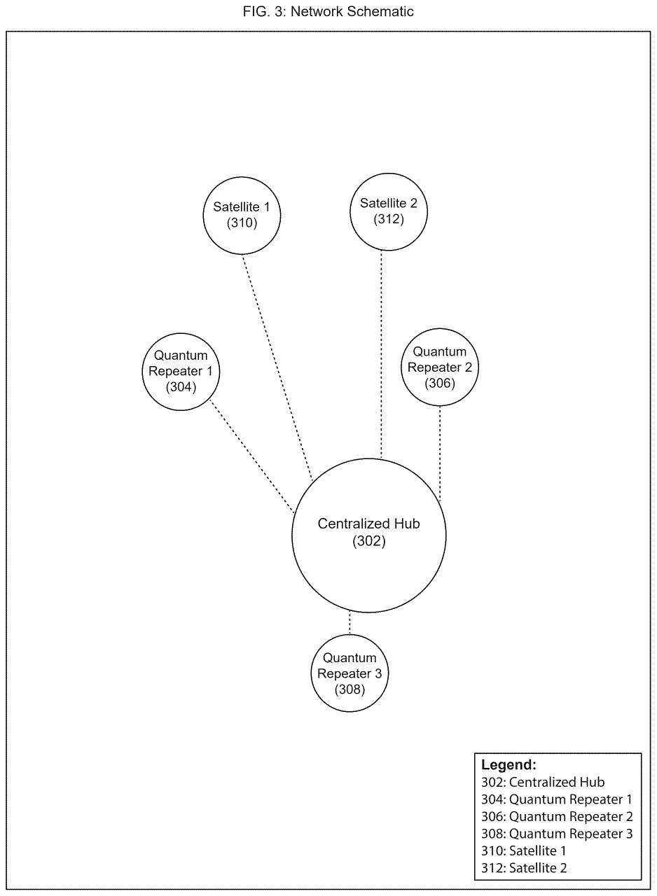

FIG. 4: Quantum repeater with multi-memory arrays, Bell-state measurement components, and tamper-proof SNSPDs.

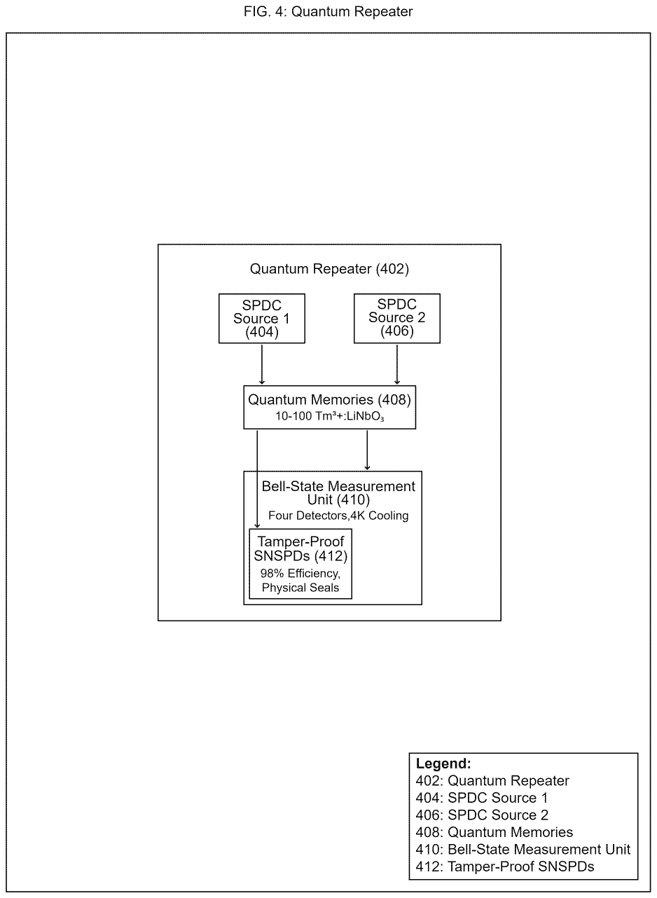

FIG. 5: AI anomaly detection module with TensorFlow neural network for photon state monitoring.

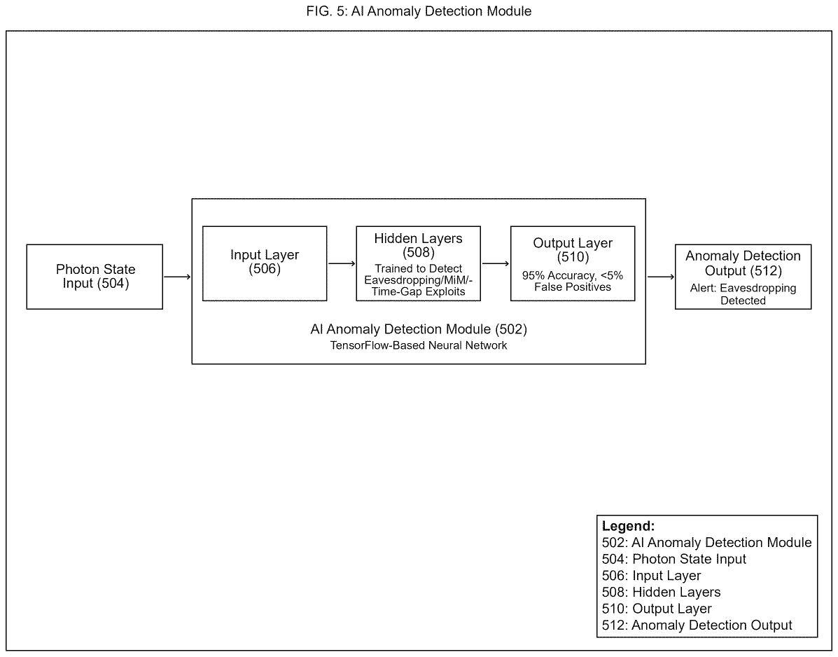

### DETAILED DESCRIPTION

The Quantum Entanglement Transaction Security (QETS) system and method provide a quantum-safe solution for authenticating high-value transactions in finance, voting, and IoT, addressing vulnerabilities such as eavesdropping, man-in-the-middle attacks, time-gap exploits, and device-dependent flaws. The system integrates quantum entanglement, advanced tamper detection, and redundant verification to ensure transaction integrity, leveraging a scalable photon transmission network.

### System Components

Entanglement Generation Module: The module uses spontaneous parametric down-conversion (SPDC) to produce entangled photon pairs at 1550 nm, achieving a rate of approximately 10\hat{ }8 pairs per second with a fidelity of at least 95%. The SPDC source comprises a 20 mm lithium niobate crystal, a 100 m W laser, beam splitters, and mirrors, operating in a Bell state (|_{ψ}>=(|00>+|11>)/√2). Multi-wavelength multiplexing enhances output capacity, enabling high-throughput transaction authentication.

Photon Transmission Network: The network distributes entangled photons over at least 50 kilometers with a total loss of less than 10 dB, comprising:
1. Centralized hubs with high-capacity SPDC sources for photon generation.
2. Single-mode fiber optic channels with a loss of less than 0.2 dB/km, employing a dense wavelength division multiplexing (DWDM) system with at least 8 channels (C-band classical, O-band quantum) and crosstalk below 30 dB.
3. Quantum repeaters spaced at 50 to 200 kilometer intervals, each including dual SPDC sources, 10-100 Tm³⁺:LiNbO₃ quantum memories, and a Bell-state measurement unit with four SNSPDs in 4K cryostats, supporting entanglement swapping and pre-distribution of photons to memories for enhanced processing speed.
4. Satellite links with adaptive optics for global transaction authentication, enabling connectivity across major economic hubs.

Verification Module: The module confirms entanglement for transaction authentication, comprising at least two Bell-state analyzers, each with four SNSPDs operating at 1550 nm with an efficiency of at least 95% in 4K cryostats. Surface code error correction maintains an error rate below 5%, ensuring reliable verification. Photonic chips integrate the analyzers for end-user deployment.

AI Anomaly Detection Module: Implemented on a processor, the module uses a TensorFlow-based neural network to monitor photon states in real-time, detecting manipulations indicative of eavesdropping, man-in-the-middle attacks, or time-gap exploits with an accuracy of at least 95% and a false positive rate below 5%. The module enhances security by identifying quantum-specific threats, complementing entanglement verification.

Redundant Classical Verification Module: The module applies AES-256 signatures to cross-validate quantum authentication results, preventing false authorizations. Integrated with the control system, it ensures compliance with GDPR and CMMC cybersecurity standards, addressing vulnerabilities such as time-gap exploits.

Tamper-Proof Mechanism: Applied to SNSPDs, the mechanism includes physical seals and calibration protocols to maintain an efficiency of at least 98%, mitigating device-dependent vulnerabilities. The seals prevent unauthorized access or tampering, ensuring detector integrity.

Control System: Executed on a processor, the control system processes at least 10\hat{ }8 quantum events per second with a latency of less than 1 millisecond. Implemented in C++ and Python with Qiskit integration, it supports hybrid quantum-classical routing at 100 Mbps quantum and 10 Gbps classical speeds. The system integrates all modules, coordinating entanglement generation, photon distribution, verification, AI anomaly detection, AES-256 validation, and tamper-proof mechanisms.

### Method

The QETS method secures transactions as follows:
1. Generate entangled photon pairs at a rate of at least 10\hat{ }8 pairs per second with 95% fidelity using an SPDC source at 1550 nm.
2. Distribute the pairs over a single-mode fiber optic network for at least 50 kilometers, using quantum repeaters for entanglement swapping across 50 to 200 kilometer segments, with pre-distribution to quantum memories and dynamic adjustment based on network conditions.
3. Verify entanglement using Bell-state analyzers with SNSPDs (95% efficiency) to authenticate a transaction.
4. Monitor photon states in real-time with an AI anomaly detection module (TensorFlow, 95% accuracy, <5% false positives) to detect eavesdropping, man-in-the-middle attacks, or time-gap exploits.
5. Validate the transaction with AES-256 signatures to prevent false authorizations.
6. Secure SNSPDs with tamper-proof seals to maintain 98% efficiency and mitigate device vulnerabilities.
7. Authorize the transaction using a control system processing 10\hat{ }8 events per second.

### Example

A $1,000 online purchase: A payment processor generates entangled photons via an SPDC source and distributes them over 500 km using three quantum repeaters on a fiber network. The seller verifies entanglement with a Bell-state analyzer in 5 milliseconds, while the AI module monitors for tampering and AES-256 signatures validate the transaction, completing the secure purchase.

1. A quantum-safe transaction security system for authenticating high-value transactions, comprising: an entanglement generation module configured to produce entangled photon pairs at a rate of at least 10\hat{ }8 pairs per second with a fidelity of at least 95% at a wavelength of 1550 nm using spontaneous parametric down-conversion (SPDC); a photon transmission network comprising single-mode fiber optic channels with a loss of less than 0.2 dB/km and quantum repeaters, configured to distribute the entangled photon pairs over at least 50 kilometers; a verification module comprising at least one Bell-state analyzer with superconducting nanowire single-photon detectors (SNSPDs) having an efficiency of at least 95%, configured to verify entanglement for transaction authentication; an artificial intelligence (AI) anomaly detection module, implemented on a processor, configured to monitor photon states in real-time and detect manipulations indicative of eavesdropping, man-in-the-middle attacks, or time-gap exploits with an accuracy of at least 95%; a redundant classical verification module configured to apply AES-256 signatures to validate transaction authorizations, preventing false positives; a tamper-proof mechanism applied to the SNSPDs, configured to ensure an efficiency of at least 98% and mitigate device-dependent vulnerabilities through physical seals; and a control system, executed on a processor, configured to process at least 10\hat{ }8 quantum events per second with a latency of less than 1 millisecond, integrating the entanglement generation module, photon transmission network, verification module, AI anomaly detection module, redundant classical verification module, and tamper-proof mechanism to authenticate transactions for finance, voting, or Internet of Things (IoT) applications.

2. The system of claim 1, wherein the entanglement generation module comprises an SPDC source with a lithium niobate crystal and a 100 mW laser, generating entangled photon pairs in a Bell state (|_{ψ}>=(|00>+|11>)/√2) with multi-wavelength multiplexing.

3. The system of claim 1, wherein the photon transmission network employs a dense wavelength division multiplexing (DWDM) system with at least 8 channels, including separate classical and quantum bands, maintaining crosstalk below 30 dB.

4. The system of claim 1, wherein the verification module includes at least two Bell-state analyzers, each with four SNSPDs operating at 1550 nm in 4K cryostats, and implements surface code error correction with an error rate of less than 5%.

5. The system of claim 1, wherein the AI anomaly detection module utilizes a TensorFlow-based neural network trained to identify photon state manipulations, achieving a false positive rate of less than 5%.

6. The system of claim 1, wherein the redundant classical verification module integrates with the control system to cross-validate quantum authentication results using AES-256 signatures, ensuring compliance with GDPR and CMMC cybersecurity standards.

7. The system of claim 1, wherein the quantum repeaters are spaced at intervals of 50 to 200 kilometers, each including dual SPDC sources, an array of at least ten Tm³⁺:LiNbO₃ quantum memories, and a Bell-state measurement unit with four SNSPDs.

8. The system of claim 1, wherein the photon transmission network further comprises satellite links with adaptive optics for global transaction authentication.

9. The system of claim 1, wherein the control system employs C++ and Python software with Qiskit integration, supporting hybrid quantum-classical routing at 100 Mbps quantum and 10 Gbps classical speeds.

10. The system of claim 1, wherein the tamper-proof mechanism includes physical seals and calibration protocols to maintain SNSPD integrity against unauthorized access or tampering.

11. A method for quantum-safe transaction security, comprising: generating entangled photon pairs at a rate of at least 10\hat{ }8 pairs per second with a fidelity of at least 95% using an SPDC source operating at 1550 nm; transmitting the entangled photon pairs over a single-mode fiber optic network for at least 50 kilometers with a loss of less than 0.2 dB/km, using quantum repeaters for entanglement swapping; verifying entanglement using at least one Bell-state analyzer with SNSPDs having an efficiency of at least 95% to authenticate a transaction; monitoring photon states in real-time with an AI anomaly detection module to detect manipulations indicative of eavesdropping, man-in-the-middle attacks, or time-gap exploits with an accuracy of at least 95%; validating the transaction with redundant AES-256 signatures to prevent false authorizations; securing the SNSPDs with tamper-proof seals to maintain an efficiency of at least 98% and mitigate device-dependent vulnerabilities; and authorizing the transaction using a control system processing at least 10\hat{ }8 quantum events per second for finance, voting, or IoT applications.

12. The method of claim 11, wherein the AI anomaly detection module employs a TensorFlow-based neural network to identify photon state manipulations with a false positive rate of less than 5%.

13. The method of claim 11, wherein transmitting the entangled photon pairs includes pre-distributing photons to quantum memories within the quantum repeaters to enhance transaction processing speed.

14. The method of claim 11, wherein the quantum repeaters swap entanglement across 50 to 200 kilometer segments, dynamically adjusted based on network conditions.
